(19) United States
(12) Patent Application Publication
(10) Pub. No.: US 2005/0034296 A1
(43) Pub. Date: Feb. 17, 2005

(54) Method of forming a transformer winding with rectangular copper wire

(76) Inventors: Harold R. Younger, Halifax, VA (US); Egil Stryken, Solbergelva (NO); John Wallumrod, Hof (NO)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/640,221

(22) Filed: Aug. 12, 2003

(51) Int. Cl. H01F 27/02

(52) U.S. Cl. 29/602.1; 29/605; 29/606; 336/92

(57) ABSTRACT

A preferred method for forming a transformer winding includes providing a length of copper wire having a substantially circular cross section, flattening the length of copper wire in two dimensions on a substantially simultaneous basis, and winding the length of copper wire into a first layer of adjacent turns.

### FIELD OF THE INVENTION

The present invention relates generally to transformers used for voltage transformation. More particularly, the invention relates to a transformer winding (coil) formed using rectangular copper wire.

### BACKGROUND OF THE INVENTION

Transformer windings are typically formed by winding an electrical conductor, such as copper or aluminum wire, on a continuous basis. The wire can be wound around a mandrel, or directly onto a winding leg of the transformer core. The wire is wound into a plurality of turns in side by side relationship to form a first layer of turns. A first layer of insulating material is subsequently placed around the first layer of turns. The wire is wound into a second plurality of turns over the first layer of insulating material, thereby forming a second layer of turns.

A second layer of insulating material is subsequently placed over the second layer of turns. The wire is then wound into a third plurality of turns over the second layer of insulation, thereby forming a third layer or turns. The above procedure can be repeated until a predetermined number of turn layers have been formed.

The “fill factor” of a transformer winding represents the ratio of the wound area to the usable window area for the transformer winding. The wound area equals the total number of turns in the transformer winding multiplied by the cross-sectional area of the wire. The usable window area represents the available window area for the transformer winding minus the portion of the available window area rendered unusable due to the particular cross-sectional shape of the conductor used to form the transformer winding.

A large fill factor is generally considered desirable for a number of reasons. For example, increasing the fill factor can decrease transformer losses caused by factors such as stray capacitance, and can thereby lower the operating cost of a transformer.

Increasing the fill factor can also reduce the total number of wire layers required in a given application. Reducing the number of wire layers can reduce the amount of material needed to manufacture the transformer winding, and can thus lower the initial cost of the transformer winding. Reducing the number of wire layers can also lead to reductions in the overall dimensions of the transformer winding (and the outer casing of the transformer), and can lower the amount of cooling medium required by the transformer.

Increasing the fill factor of a transformer winding can also increase the amount of contact and the bond strength between the wire and the insulating material of the transformer winding, thus improving the short-circuit strength of the transformer winding.

Transformer windings formed from wire having a substantially rectangular cross section (hereinafter referred to as “rectangular wire”), in general, have a higher fill factor than comparable transformer windings formed from wire having other types of cross-sections, e.g., round wire (wire having a substantially circular cross-section) or two-way flattened-round wire.

In particular, the substantially flat sides of the rectangular wire can substantially minimize or eliminate gaps between adjacent turns of the wire, and between the wire and adjacent insulating material. For example, the space efficiency within transformer windings formed using rectangular wire, it is believed, can be as high as approximately 97 percent. The space efficiency within transformer windings formed from round or two-way flattened-round wire, it is believed, can only reach approximately 76 percent and approximately 85 percent, respectively.

The stretching occurs during the flattening operation used to form rectangular wire increases the axial length of the wire. Thus, the total amount of wire needed to manufacture a transformer winding using rectangular wire is believed to be less than that needed to manufacture a transformer winding of comparable capacity using round or two-way flattened-round wire. (The increased losses causes by the decrease in cross-sectional area caused by the flattening operation are believed to be substantially offset by the decreased losses resulting from the reduced mean diameter of the winding that results from the use of rectangular wire.)

Moreover, the flattening operation used to form the rectangular wire, it is believed, makes the width and height of the rectangular wire more uniform along the length thereof than circular or two-way flattened-round wire. The more uniform dimensions of the rectangular wire can further minimize gaps between adjacent turns of the wire, and between the wire and adjacent insulating material. The more uniform width and height of the rectangular wire can also minimize the potential for overlap between adjacent turns (such overlap can increase the potential for failure of the transformer winding). These characteristics can be particularly beneficial when the transformer winding is wound on an automated basis.

Moreover, it is believed that the use of rectangular wire can reduce the variability in the dimensions of the transformer winding, and can thus yield a reduction in yoke length. It is also believed that the use of rectangular wire can minimize eddy current losses in relation to round wire, and can thereby lower the operating cost of the transformer.

Rectangular wire is typically formed from round wire. In particular, the round wire is initially flattened in a first dimension, i.e., the round wire is flattened so as to form two substantially flat, parallel surfaces thereon. The flattening operation is usually performed by drawing the wire through two opposing rollers spaced apart by a distance corresponding to the desired thickness of the wire in the first dimension. (This technique is commonly referred to as “two-way post rolling.”)

The wire is subsequently subject to a second forming operation that flattens the wire in a second dimension substantially perpendicular to the first dimension, in a manner substantially similar to the first flattening operation. In other words, two additional substantially flat, parallel surfaces are formed on the wire, with the additional surfaces being substantially perpendicular to the previously-formed surfaces. The additional surfaces are spaced apart by a distance corresponding to the desired thickness of the wire in the second dimension. The initial and subsequent flattening operations are typically conducted at or near ambient temperature, i.e., the wire is cold worked during the flattening operations.

The use of copper wire in a transformer winding is generally considered desirable due to the relatively high conductivity of copper. (High conductivity can help to minimize the “I²R” losses that occur during operation of a transformer.) Copper wire, however, can be difficult to form into a rectangular configuration. In particular, the initial forming operation that flattens the copper wire in the first dimension typically causes the wire to undergo substantial work hardening, i.e., an increase in hardness that accompanies plastic deformation of a metal at a temperature below the recrystalization temperature range of the metal. The increased hardness of the wire following the initial flattening operation can make the second flattening operation difficult to perform in a cost and time-effective manner. Moreover, the increased hardness is believed to limit the degree to which the wire can be flattened during the second flattening operation.

### SUMMARY OF THE INVENTION

A preferred method for forming a transformer winding comprises providing a length of copper wire having a substantially circular cross section, flattening the length of copper wire in two dimensions on a substantially simultaneous basis, and winding the length of copper wire into a first layer of adjacent turns.

Another preferred method for manufacturing a transformer winding comprises drawing copper wire having a substantially circular cross section through a plurality of rollers to plastically deform the copper wire and form a first and a second pair of substantially parallel and substantially flat surfaces on the copper wire on a substantially simultaneous basis, and winding the copper wire on one of a winding leg of a transformer core and a mandrel.

Another method for forming a transformer winding comprises post rolling a length of round copper wire in two dimensions on a substantially simultaneous basis to form the length of round copper wire into a length of rectangular copper wire, and winding the length of rectangular copper wire to form a first layer of adjacent turns.

A preferred method for manufacturing a transformer comprises providing a length of copper wire having a substantially circular cross section, and flattening the length of copper wire in two dimensions on a substantially simultaneous basis to form a first and a second pair of substantially flat and substantially parallel surfaces on the length of copper wire. The preferred method further comprises fixedly coupling a winding leg of a core of the transformer to a first yoke of the core of the transformer, winding the length of copper wire onto one of the winding leg and a mandrel, and fixedly coupling a second yoke of the core of the transformer to the winding leg.

### BRIEF DESCRIPTION OF THE DRAWINGS

The foregoing summary, as well as the following detailed description of a preferred method, are better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a side view a transformer having primary and secondary windings formed in accordance with a preferred method for forming a transformer winding;

FIG. 2 is a side view of a primary winding and a winding leg of the transformer shown in FIG. 1;

FIG. 3 is a magnified cross-sectional view of the primary winding and the winding leg shown in FIGS. 1 and 2, taken through the line “A-A” of FIG. 2;

FIG. 4 is a front view of a roller system for forming rectangular copper wire for use in the primary winding shown in FIGS. 1-3;

FIG. 5 is a side view of the roller system shown in FIG. 4;

FIG. 6 is a side view of the roller system shown in FIGS. 4 and 5, and a motorized spool for drawing round copper wire through the roller system, and showing the round copper wire being formed into rectangular copper wire for use in the primary winding shown in FIGS. 1-3;

FIG. 7A is a front view of the rectangular copper wire shown being formed in FIG. 6;

FIG. 7B is a top perspective view of the rectangular copper wire shown in FIGS. 6 and 7A;

FIG. 7C is a bottom perspective view of the rectangular copper wire shown in FIGS. 6-7B; and

FIG. 8 is a side view of the rectangular copper wire shown in FIGS. 6-7C wound on a mandrel.

### DESCRIPTION OF PREFERRED EMBODIMENTS

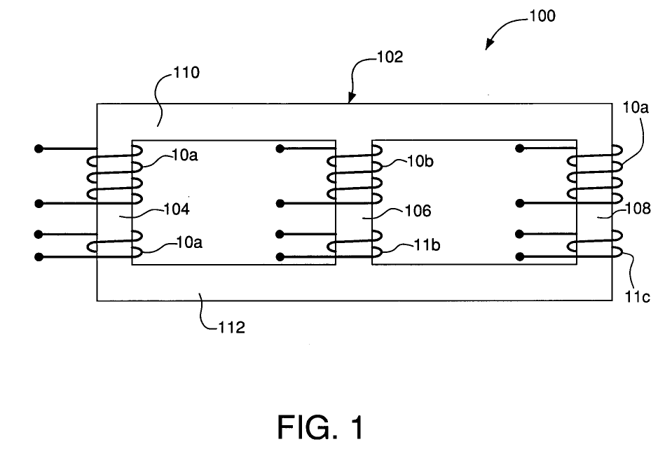

A preferred embodiment of a transformer 100 is shown in FIGS. 1 to 3. The transformer 100 comprises a conventional laminated core 102. The core 102 is formed from a suitable magnetic material such as textured silicon steel or an amorphous alloy. The core 102 comprises a first winding leg 104, a second winding leg 106, and a third winding leg 108. The core 102 also comprises an upper yoke 110 and a lower yoke 112. Opposing ends of each of the first, second, and third winding legs 104, 106, 108 are fixedly coupled to the upper and lower yokes 110, 112 using, for example, a suitable adhesive or suitable mechanical structures.

Primary windings 10a, 10b, 10c are positioned around the respective first, second, and third winding legs 104, 106, 108. Secondary windings 11a, 11b, 11c are likewise positioned around the respective first, second, and third winding legs 104, 106, 108. The primary windings 10a, 10b, 10c are substantially identical. The secondary windings 11a, 11b, 11c are also substantially identical. The primary windings 10a, 10b, 10c and the secondary windings 11a, 11b, 11c are cylindrical windings. Transformer windings of other shapes, e.g., round, rectangular, rectangular with curved sides, oval, etc., can be used in alternative embodiments of the transformer 100.

The primary windings 10a, 10b, 10c can be electrically connected in a “Delta” configuration, as is commonly known among those skilled in the art of transformer manufacture and design. The secondary windings 11a, 11b, 11c can be electrically connected in a “Delta” or a “Wye” configuration, depending on the voltage requirements of the transformer 100. (The electrical connections between the primary windings 10a, 10b, 10c and the secondary windings 11a, 11b, 11c are not shown in FIG. 1, for clarity.)

The primary windings 10a, 10b, 10c can be electrically coupled to a three-phase, alternating current (AC) power source (not shown). The secondary windings 11a, 11b, 11c can be electrically coupled to a load (also not shown). The primary windings 10a, 10b, 10c are inductively coupled to the secondary windings 10a, 10b, 10c via the core 102 when the primary windings 10a, 10b, 10c are energized by the load. More particularly, the AC voltage across the primary windings 10a, 10b, 10c sets up an alternating magnetic flux in the core 102. The magnetic flux induces an AC voltage across the secondary windings 11a, 11b, 11c (and the load connected thereto).

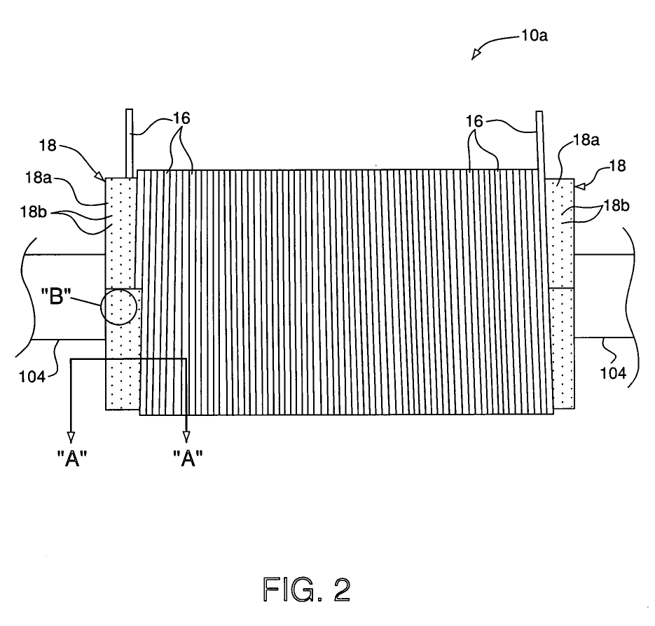

The primary winding 10a comprises an electrical conductor 16 wound around the first winding leg 104 on a continuous basis (see FIG. 2). The electrical conductor 16 is copper wire. It should be noted that the term “copper wire,” as used throughout the specification and claims, is intended to encompass wire from exclusively from copper, as well as wire formed from copper alloys.

The electrical conductor 16 is wound onto the first winding leg 104 as rectangular copper wire. The electrical conductor 16 is formed from round copper wire, i.e., copper wire having a substantially circular cross section. The electrical conductor 16, as explained in detail below, is formed from its initial round configuration into its final rectangular configuration prior to being wound.

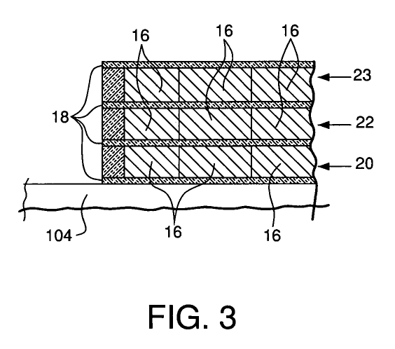

The primary winding 10a also comprises face-width sheet layer insulation. More particularly, the primary winding 10a comprises sheets of insulation 18 (see FIGS. 2 and 3). The sheets of insulation 18 can be formed, for example, from heat-curable epoxy diamond pattern coated kraft paper (commonly referred to as “DPP paper”). It should be noted that other types of insulation, such as heat-curable epoxy fully coated kraft paper or coated crepe paper, can be used in the alternative.

The primary winding 10a comprises overlapping layers of turns of the electrical conductor 16. A respective one of the sheets of insulation 18 is positioned between each of the overlapping layers of turns (see FIG. 3). The turns in each layer advance progressively across the width of the primary winding 10a. In other words, each overlapping layer of the primary winding 10a is formed by winding the electrical conductor 16 in a plurality of turns arranged in a side by side relationship across the width of the primary winding 10a.

The primary winding 10a is formed by placing one of the sheets of insulation 18 on an outer surface of the first winding leg 104 so that the sheet of insulation 18 covers a portion of the outer surface.

A first layer of turns 20 is subsequently wound onto the first winding leg 104. More particularly, the electrical conductor 16 is wound around the first winding leg 104 and over the sheet of insulation 18, until a predetermined number of adjacent (side by side) turns have been formed. The winding operation can be performed manually, or using a conventional automated winding machine such as a model AM 3175 layer winding machine available from BR Technologies GmbH.

The second layer of turns 22 is formed after the first layer of turns 20 has been formed in the above-described manner. In particular, another of the sheets of insulation 18 is placed over the first layer of turns 20 so that an edge of the sheet of insulation 18 extends across the first layer of turns 20 (see FIG. 2). The sheet of insulation 18 can be cut so that opposing ends of the sheet of insulation 18 meet as shown in FIG. 2.

The electrical conductor 16 is subsequently wound over the first layer of turns 20 and the overlying sheet of insulation 18 to form the second layer of turns 22, in the manner described above in relation to the first layer of turns 20 (see FIG. 3). In other words, the second layer of turns 22 is formed by winding the electrical conductor 16 into a series of adjacent turns progressing back across the first layer of turns 20, until a predetermined turns count is reached.

The above procedures can be repeated until a desired number of turn layers have been formed in the primary winding 10a (only three of the turn layers are depicted in FIG. 3, for clarity).

It should be noted that a continuous strip of insulating material (not shown) can be used in lieu of the sheets of insulation 18. In particular, the continuous strip of insulating material can be continuously wound ahead of the electrical conductor 16 to provide substantially the same insulating properties as the sheets of insulation 18. The insulating strip can be positioned around a particular layer of the electrical conductor 16, and then cut to an appropriate length at the end of the layer using conventional techniques commonly known to those skilled in the art of transformer design and manufacture.

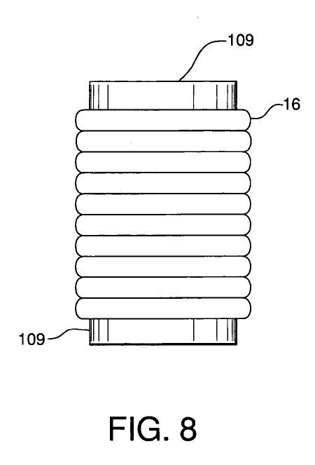

Moreover, the primary winding 10a can be wound on a mandrel and subsequently installed on the first winding leg 104, in lieu of winding the primary winding 10a directly onto the first winding leg 104 (see FIG. 8).

The secondary winding 11a can subsequently be wound on the first winding leg 104 in the manner described above in connection with the primary winding 10a. The number of turns of the electrical conductor 16 in each layer of the primary and secondary windings 10a, 11a differs. The primary and secondary windings 10a, 11a are otherwise substantially identical.

The primary windings 10b, 10c and the secondary windings 11b, 11c can be wound in the above-described manner on a simultaneous or sequential basis with the primary and secondary winding 10a, 11a.

The upper yoke 100 can be secured to the first, second, and third winding legs 104, 106, 108 after the primary windings 10a, 10b, 10c and the secondary windings 11a, 11b, 11c have been wound.

The adhesive on the sheets of insulation 18 of the primary winding 10a can subsequently be melted and cured by techniques such as placing the transformer 100 in a hot-air convection oven and heating the transformer 100 at a predetermined temperature for a predetermined period, or by applying a current through the primary windings 10a, 10b, 10c or the secondary windings 11a, 11b, 11c to generate heat.

The core 102, the primary windings 10a, 10b, 10c, and the secondary windings 11a, 11b, 11c can subsequently be installed in an outer casing (not shown). The outer casing can be filled with mineral oil to cool and further insulate the core 102, the primary windings 10a, 10b, 10c, and the secondary windings 11a, 11b, 11c.

Descriptions of additional structural elements and functional details of the transformer 100 are not necessary to an understanding of the present invention, and therefore are not presented herein.

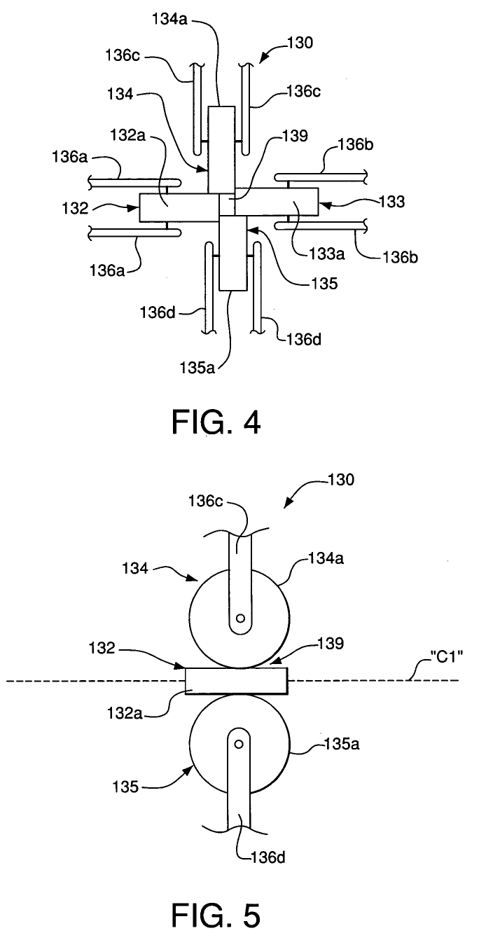

The electrical conductor 16 is formed from round copper wire into rectangular copper wire before being wound onto the first, second, and third winding legs 104, 106, 108, as noted previously. The electrical conductor 16 is formed from its initial round configuration into its final rectangular configuration using a roller system 130 (see FIGS. 4-6).

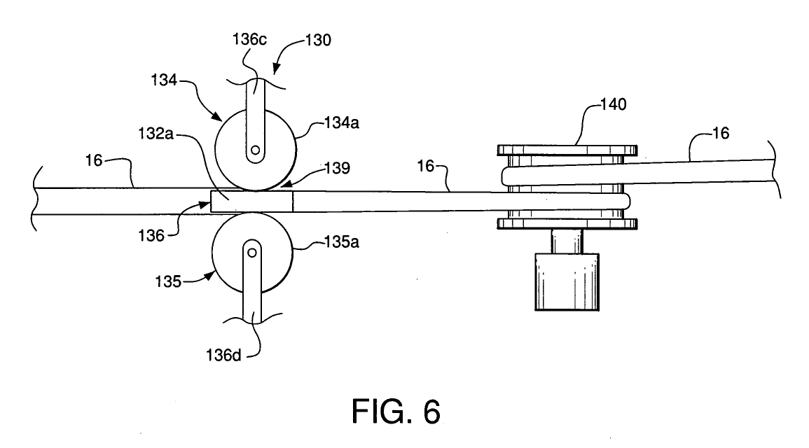

The roller system 130 comprises a first set of opposing rollers 132, 133. The rollers 132, 133 are rotatably coupled to respective supports 136a, 136b. (The support 136a is not shown in FIG. 5 or 6, for clarity.) The supports 136a, 136b restrain the rollers 132, 133 from substantial linear movement. The rollers 132, 133 each have a respective circumferentially-extending, substantially flat surface 132a, 133a. The rollers 132, 133 and the supports 136a, 136b can be of the conventional type commonly used in two-way post rolling, i.e., in flattening circular wire in one dimension.

The roller system 130 also comprises a second set of opposing rollers 134, 135. The rollers 134, 135 are rotatably coupled to respective supports 136c, 136d. The supports 136c, 136d restrain the rollers 134, 135 from substantial linear movement. The rollers 134, 135 each have a respective circumferentially-extending, substantially flat surface 134a, 135a. The rollers 134, 135 and the supports 136c, 136d are substantially identical to the respective rollers 132, 133 and supports 136a, 136b.

The axes of rotation of the rollers 132, 133 are substantially parallel. The axes of rotation of the rollers 134, 135 likewise are substantially parallel. The orientation of the rollers 132, 133 is substantially perpendicular to that of the rollers 134, 135. In other words, the axes of rotation of the rollers 132, 133 are substantially perpendicular to the axes of rotation of the rollers 134, 135.

The surfaces 132a, 133a of the respective rollers 132, 133 are spaced apart by a distance in a first direction. The distance in the first direction corresponds to a desired final dimension of the electrical conductor 16 in the first direction. The surfaces 134a, 135a of the respective rollers 134, 135 are spaced apart by a distance in a second direction substantially perpendicular to the first direction. The distance in the second direction corresponds to a desired final dimension of the electrical conductor 16 in the second direction.

The supports 136a, 136b can be variably positioned so that the spacing between the surfaces 132a, 133a can be adjusted on a manual or a computer-controlled basis, in a manner substantially identical to conventional post-rolling devices used to flatten circular wire in one dimension. The supports 136c, 136d can likewise be variably positioned so that the spacing between the surfaces 134a, 135a can be adjusted on a manual or a computer-controlled basis.

The rollers 134, 135 are positioned adjacent each of the rollers 132, 133 as shown, for example, in FIG. 4. In other words, the rollers 132, 133, 134, 135 are each located at approximately the same location along an axis “C1” that extends substantially perpendicular to each of the respective axes of rotation of the rollers 132, 133, 134, 135 (see FIG. 5). This configuration causes the surfaces 132a, 133a, 134a, 135a to define a gap 139 therebetween (see FIG. 4).

The electrical conductor 16 is formed from its initial round configuration to its final rectangular configuration by drawing the electrical conductor 16 through the gap 139. The electrical conductor 16 can be drawn through the gap 139 by a conventional motorized spool 140 of the type commonly used in the flattening of circular wire in one dimension (see FIG. 6).

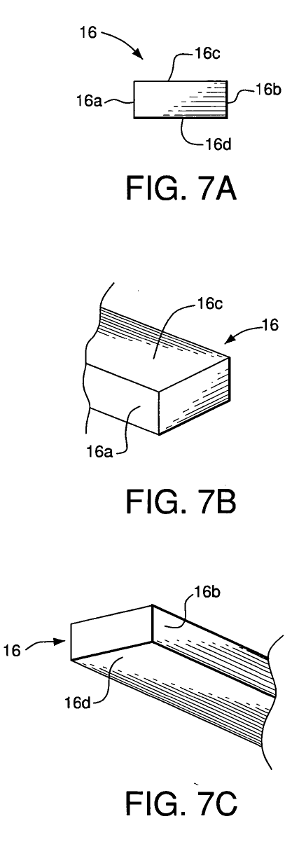

The spacing between the surfaces 132a, 133a of the respective rollers 132, 133 is less than the initial diameter of the electrical conductor 16. Moreover, the rollers 132, 133 are restrained from linear movement by the respective supports 136a, 136b, as noted above. Thus, the rollers 132, 133 plastically deform the electrical conductor 16 as the electrical conductor 16 is drawn through the gap 139. In particular, the rollers 132, 133 flatten the electrical conductor 16 so as to from two opposing substantially flat sides 16a, 16b thereon (see FIGS. 7A-7C).

The spacing between the surfaces 134a, 135a of the respective rollers 134, 135 is less than the initial diameter of the electrical conductor 16. Moreover, the rollers 134, 135 are restrained from linear movement by the respective supports 136c, 136d, as noted above. Thus, the rollers 134, 135 plastically deform the electrical conductor 16 as the electrical conductor 16 is drawn through the gap 139. In particular, the rollers 134, 135 flatten the electrical conductor 16 so as to from two opposing substantially flat sides 16c, 16d thereon. The sides 16c, 16d are substantially perpendicular to the sides 16a, 16b due to the substantially perpendicular orientation of the rollers 132, 133 in relation to the rollers 134, 135.

The rollers 132, 133, 134, 135 are each located at approximately the same location along the axis “C1,” as noted above. Hence, the surfaces 132a, 133a, 134a, 135a each contact substantially the same axial (lengthwise) location on the electrical conductor 16. The sides 16a, 16b therefore are formed on a substantially simultaneous basis with the sides 16c, 16d.

Forming the sides 16a, 16b on a substantially simultaneous basis with the sides 16c, 16d, it is believed, can substantially reduce or eliminate the difficulties associated with the work hardening of the electrical conductor 16 caused by the forming operation. In particular, forming the sides 16a, 16b on a simultaneous, vs. sequential, basis with the sides 16c, 16d avoids the need to form the sides 16c, 16d after the electrical conductor 16 has been work hardened by the formation of the sides 16a, 16b (or vice versa). Moreover, it is believed that forming the sides 16a, 16b on a simultaneous, vs. sequential, basis with the sides 16c, 16d reduces the overall amount of work hardening experienced by the electrical conductor 16 due to the forming operation.

A suitable system that can be programmed to perform the above-described flattening operation on an automated basis is available from LAE Electronic sr1.

The electrical conductor 16, after being formed into a rectangular configuration, can be fed directly from the motorized spool 140 to a winding machine and rolled onto the first, second, or third winding legs 104, 106, 108 of the core 102. In the alternative, the electrical conductor 16 can be rolled onto a mandrel and subsequently installed on the first, second, or third winding legs 104, 106, 108 (see FIG. 8). Moreover, the electrical conductor 16 can be stored on the motorized spool 140, or transferred to another spool (not shown) and stored prior to being wound onto the first, second, or third winding legs 104, 106, 108.

The use of copper wire in a transformer winding, as discussed above, is desirable due to its relatively high conductivity. The use of rectangular wire in a transformer winding is also desirable, due to the relatively high fill factors can be achieved using such wire. Increasing the fill factor of a transformer winding can lower the initial cost and the operating costs of a transformer such as the transformer 100. Increasing the fill factor can also lower transformer losses, and can reduce the overall dimensions and cooling requirements of a transformer.

Copper wire, however, can be difficult to flatten in two dimensions due to its work-hardening characteristics, as noted previously. Forming the electrical conductor 16 in the above-described manner, it is believed, can substantially eliminate these difficulties, and can thus facilitate the production and use of rectangular copper wire in transformer windings in a cost and time-effective manner.

Moreover, it is believed that flattening the electrical conductor 16 in the above-described manner can lead to relatively high uniformity in the width and height of the electrical conductor 16 along the length thereof. Increasing the uniformity of these dimensions, as discussed above, can increase the fill factor of a transformer winding such as the primary winding 10a, and can improve the manufacturability of the primary winding 10a where the primary winding 10a is wound on an automated basis.

Flattening the electrical conductor 16 in the above-described manner can also facilitate the manufacture of batches of rectangular copper wire having different dimensions, using a common stock of round copper wire. Hence, reductions in inventory requirements and manufacturing costs can potentially be achieved by flattening the electrical conductor 16 in the above-described manner.

1. A method for forming a transformer winding, comprising:
providing a length of copper wire having a substantially circular cross section;
flattening the length of copper wire in two dimensions on a substantially simultaneous basis; and
winding the length of copper wire into a first layer of adjacent turns.

2. The method of claim 1, further comprising placing an insulating material over the first layer of adjacent turns and winding the length of copper wire into a second layer of adjacent turns over the insulating material.

3. The method of claim 1, wherein winding the length of copper wire into a first layer of adjacent turns comprises winding the length of copper wire into the first layer of adjacent turns on one of a winding leg of a transformer core and a mandrel.

4. The method of claim 1, wherein flattening the length of copper wire in two dimensions on a substantially simultaneous basis comprises drawing the length of copper wire through a first and a second set of rollers so that the first and the second set of rollers simultaneously contact substantially the same axial location on the length of copper wire.

5. The method of claim 4, wherein:
the first set of rollers comprises a first and a second roller each having a circumferentially-extending surface, the circumferentially-extending surfaces of the first and second rollers being spaced apart by a distance substantially equal to a desired width of the length of copper wire; and
the second set of rollers comprises a third and a fourth roller each having a circumferentially-extending surface, the circumferentially-extending surfaces of the third and fourth rollers being spaced apart by a distance substantially equal to a desired height of the length of copper wire.

6. The transformer of claim 1, wherein flattening the length of copper wire in two dimensions on a substantially simultaneous basis comprises drawing the length of copper wire through a gap defined by a first and a second set of rollers.

7. The transformer of claim 1, wherein:
flattening the length of copper wire in two dimensions on a substantially simultaneous basis comprises drawing the length of copper wire through a first and a second set of rollers on a substantially simultaneous basis;
the first set of rollers comprises a first and a second roller each having an axis of rotation, the axes of rotation of the first and second rollers being substantially parallel; and
the second set of rollers comprises a third and a fourth roller each having an axis of rotation, the axes of rotation of the third and fourth rollers being substantially parallel, and the axes of rotation of the third and fourth rollers being substantially perpendicular to the axes of rotation of the first and second rollers.

8. The method of claim 1, wherein flattening the length of copper wire in two dimensions on a substantially simultaneous basis comprises plastically deforming the length of copper wire to form a first and a second pair of substantially flat and substantially parallel surfaces, the first pair of substantially flat and substantially parallel surfaces being substantially perpendicular to the second pair of substantially flat and substantially parallel surfaces.

9. The method of claim 8, wherein the first pair of substantially flat and substantially parallel surfaces are spaced apart by a distance corresponding to a desired width of the length of copper wire, and the second pair of substantially flat and substantially parallel surfaces are spaced apart by a distance corresponding to a desired height of the length of copper wire.

10. A transformer winding formed in accordance with the method of claim 1.

11. A transformer, comprising a core having a winding leg and a first and a second yoke fixedly coupled to the winding leg, and a transformer winding formed in accordance with the method of claim 1 and positioned on the winding leg.

12. The method of claim 4, wherein drawing the length of copper wire through a first and a second set of rollers so that the first and the second set of rollers simultaneously contact substantially the same axial location on the length of copper wire comprises drawing the length of copper wire onto a motorized spool.

13. The method of claim 5, wherein each of the first and the second set of rollers is rotatably coupled to a respective support, and the method further comprises adjusting a position of one or more of the supports so that the circumferentially-extending surfaces of the first and second rollers are spaced apart by the distance substantially equal to a desired width of the length of copper wire, and the circumferentially-extending surfaces of the third and fourth rollers are spaced apart by the distance substantially equal to a desired height of the length of copper wire.

14. The method of claim 3, wherein winding the length of copper wire into the first layer of adjacent turns on one of a winding leg of a transformer core and a mandrel comprises winding the length of copper wire into the first layer of turns on the mandrel, and the method further comprises installing the length of copper wire on the winding leg after winding the length of copper wire into the first layer of turns.

15. A method for manufacturing a transformer winding, comprising:
drawing copper wire having a substantially circular cross section through a plurality of rollers to plastically deform the copper wire and form a first and a second pair of substantially parallel and substantially flat surfaces on the copper wire on a substantially simultaneous basis; and
winding the copper wire on one of a winding leg of a transformer core and a mandrel.

16. The method of claim 15, wherein winding the copper wire on one of a winding leg of a transformer core and a mandrel comprises winding the copper wire to form a first layer of adjacent turns of the copper wire on the one of a winding leg and a mandrel.

17. The method of claim 16, further comprising placing an insulating material on the first layer of adjacent turns, and wherein winding the copper wire on one of a winding leg of a transformer core and a mandrel further comprises winding the copper wire over the insulating material to form a second layer of adjacent turns over the insulating material.

18. The method of claim 15, wherein each of the rollers has a substantially flat, circumferentially-extending surface and drawing copper wire having a substantially circular cross section through a plurality of rollers to plastically deform the copper wire and form a first and a second pair of substantially parallel and substantially flat surfaces on the copper wire on a substantially simultaneous basis comprises drawing the copper wire through a gap formed by the substantially flat, circumferentially-extending surfaces of the rollers.

19. The method of claim 15, wherein drawing copper wire having a substantially circular cross section through a plurality of rollers to plastically deform the copper wire and form a first and a second pair of substantially parallel and substantially flat surfaces on the copper wire on a substantially simultaneous basis comprises drawing the copper wire through the plurality of rollers so that the plurality of rollers simultaneously contact substantially the same axial location on the copper wire.

20. The method of claim 15, wherein drawing copper wire having a substantially circular cross section through a plurality of rollers to plastically deform the copper wire and form a first and a second pair of substantially parallel and substantially flat surfaces on the copper wire on a substantially simultaneous basis comprises:
drawing the copper wire through a first and a second of the rollers each having a substantially flat, circumferentially-extending surface, the substantially flat, circumferentially-extending surfaces being spaced apart by a distance corresponding to a desired width of the copper wire; and
drawing the copper wire through a third and a fourth of the rollers each having a substantially flat, circumferentially-extending surface, the substantially flat, circumferentially-extending surfaces of the third and fourth rollers being spaced apart by a distance corresponding to a desired height of the copper wire.

21. The method of claim 15, wherein each of the first pair of substantially parallel and substantially flat surfaces on the copper wire is substantially perpendicular to each of the second pair of substantially parallel and substantially flat surfaces on the copper wire.

22. The method of claim 15, wherein each of the plurality of rollers has a circumferentially-extending surface and is rotatably coupled to a respective support, and the method further comprises adjusting a position of one or more of the supports so that the circumferentially-extending surfaces of a first and a second of the rollers are spaced apart by a distance substantially equal to a desired width of the copper wire, and the circumferentially-extending surfaces of a third and a fourth of the rollers are spaced apart by a distance substantially equal to a desired height of the copper wire.

23. The method of claim 15, wherein:
the plurality of rollers comprises a first, a second, a third, and a fourth roller;
the first and second rollers each have an axis of rotation;
the axes of rotation of the first and second rollers are substantially parallel;
the third and fourth rollers each have an axis of rotation;
the axes of rotation of the third and fourth rollers are substantially parallel; and
the axes of rotation of the third and fourth rollers are substantially perpendicular to the axes of rotation of the first and second rollers.

24. A transformer winding formed in accordance with the method of claim 15.

25. A method for forming a transformer winding, comprising:
post rolling a length of round copper wire in two dimensions on a substantially simultaneous basis to form the length of round copper wire into a length of rectangular copper wire; and
winding the length of rectangular copper wire to form a first layer of adjacent turns.

26. The method of claim 25, wherein winding the length of rectangular copper wire to form a first layer of adjacent turns comprises winding the length of rectangular copper on one of a winding leg of a transformer and a mandrel.

27. A method for manufacturing a transformer, comprising:
providing a length of copper wire having a substantially circular cross section;
flattening the length of copper wire in two dimensions on a substantially simultaneous basis to form a first and a second pair of substantially flat and substantially parallel surfaces on the length of copper wire;
fixedly coupling a winding leg of a core of the transformer to a first yoke of the core of the transformer;
winding the length of copper wire onto one of the winding leg and a mandrel; and
fixedly coupling a second yoke of the core of the transformer to the winding leg.

28. The method of claim 27, wherein winding the length of copper wire onto one of the winding leg and a mandrel comprises winding the length of copper wire onto the mandrel, and the method further comprises installing the length of copper wire on the winding leg after winding the length of copper wire onto the mandrel.

29. A transformer manufactured in accordance with the method of claim 27.
